(19) United States
(12) Patent Application Publication
(10) Pub. No.: US 2012/0235778 A1
(43) Pub. Date: Sep. 20, 2012

(54) R-T-B RARE EARTH SINTERED MAGNET

(75) Inventors: Ryota KUNIEDA, Tokyo (JP); Tetsuya CHIBA, Tokyo (JP); Takuma HAYAKAWA, Tokyo (JP); Atsushi FUJIWARA, Tokyo (JP)

(73) Assignee: TDK Corporation, Chuo-ku (JP)

(21) Appl. No.: 13/417,784

(22) Filed: Mar. 12, 2012

(30) Foreign Application Priority Data
Mar. 18, 2011 (JP) 2011-060523

(51) Int. Cl. H01F 7/02

(52) U.S. Cl. 335/302

(57) ABSTRACT

The invention provides an R-T-B rare earth sintered magnet 100 including R₂T₁₄B-containing crystal grains as the main phase 10, and having an R_{L}-T-M₁ based compound 12 at the grain boundary triple points, wherein R represents a rare earth element, T represents at least one element selected from among Fe, Co and Cu, B represents boron, R_{L} represents a light rare earth element, and M₁ represents at least one element selected from among Al, Zn and Ga.

### BACKGROUND OF THE INVENTION

1. Field of the Invention

The present invention relates to an R-T-B rare earth sintered magnet.

2. Related Background Art

R-T-B rare earth sintered magnets are used in various types of motors, such as HDD voice coil motors, and in generators, because of their high magnetic properties. With the increasing concerns regarding environmental problems in recent years, demand is rapidly rising for hybrid vehicles and wind power generators. Along with this trend, greater performance is also being sought for motors and generators, leading to demands for development of R-T-B rare earth sintered magnets with superior magnetic properties.

R-T-B rare earth sintered magnets used in hybrid vehicles and for wind power generation are employed in environments with a large range of temperature variation. For this reason, measures must be taken against irreversible thermal demagnetization in order to avoid impairment of the magnetic properties with prolonged use in such environments. For R-T-B rare earth sintered magnets, therefore, it is essential to improve the coercive force, which is an index of resistance to demagnetization.

Methods of improving the coercive force have been proposed in which a portion of R in the R₂T₁₄B phase (main phase) that exhibits the magnetic force in an R-T-B rare earth sintered magnet is replaced with a heavy rare earth element such as Dy or Tb. However, a main phase in which a portion of the R is constituted by a heavy rare earth element differs from a main phase in which R consists of a light rare earth element such as Nd or Pr, and the magnetization mechanism becomes altered to ferrimagnetism. The saturation magnetization is therefore reduced, and as a result, the residual magnetic flux density, as an index of the strength of magnetic force of the permanent magnet, is lowered. Also, because heavy rare earth elements such as Dy and Tb are very expensive, their use in large amounts significantly increases cost.

A different method proposed for increasing the coercive force is to inhibit coarsening of the crystal grains in the main phase or to control the Cu content at the grain boundaries, as described in Japanese Patent No. 3921399, for example.

### SUMMARY OF THE INVENTION

However, because the coercive force of conventional R-T-B rare earth sintered magnets has been insufficient, it has been necessary to attempt micronization of the crystal grain size and modification of the grain boundary depending on the element added, or to increase the amount of heavy rare earth element used to increase the coercive force. In particular, R-T-B rare earth sintered magnets used in hybrid vehicles and the like are used in environments with high temperature and large temperature change, and therefore high coercive force must be maintained, making it difficult to reduce the amount of heavy rare earth element used.

The present invention has been accomplished in light of this situation, and its object is to provide an R-T-B rare earth sintered magnet having sufficiently high coercive force without increasing the amount of heavy rare earth element used.

With the aim of achieving this object, the present inventors diligently studied the effects of heat treatment conditions for R-T-B rare earth sintered magnets on the structures of sintered materials, attempting to improve the magnetic properties by controlling the sintered material structures. As a result, it was found that by adjusting the heat treatment conditions for a sintered material comprising prescribed elements, a specific compound is deposited which comprises R_{L}, T and M₁ as constituent elements, and the aforementioned problems were thereby solved.

Specifically, the invention provides an R-T-B rare earth sintered magnet comprising R₂T₁₄B-containing crystal grains as the main phase, and having an R_{L}-T-M₁ based compound at the grain boundary triple points, wherein R represents a rare earth element, T represents at least one type of element selected from among Fe, Co and Cu, B represents boron, R_{L} represents a light rare earth element, and M₁ represents at least one type of element selected from among aluminum (Al), zinc (Zn) and gallium (Ga).

Since the R-T-B rare earth sintered magnet of the invention has an R_{L}-T-M₁ based compound at the grain boundary triple points, the coercive force can be sufficiently increased. While the reason for the increased coercive force is not fully understood, it is believed to be due to the fact that the compound comprising Fe or Co as a constituent element is soft magnetic, while the R_{L}-T-M₁ based compound is not magnetic. Also, since the R_{L}-T-M₁ based compound has a light rare earth element (R_{L}) as the constituent element, another possible factor is that when the R-T-B rare earth sintered magnet includes a heavy rare earth element, the ratio of the heavy rare earth element with respect to the light rare earth element in the R-rich phase produced at the grain boundary is relatively increased.

The R-T-B rare earth sintered magnet of the invention preferably includes plate crystals comprising an R_{L}-T-M₁ based compound at the grain boundary triple points. Including such plate crystals can increase the strength of the R-T-B rare earth sintered magnet. The plate crystals more preferably comprise an R_{L}-T-M₁ based compound as the major component.

In the R-T-B rare earth sintered magnet of the invention, the ratio of the area of each of the plate crystals comprising the R_{L}-T-M₁ based compound with respect to the area of the grain boundary triple points, based on a cross-section, is preferably 0.01-0.22. By including plate crystals comprising an R_{L}-T-M₁ based compound in this area ratio, it is possible to further increase the coercive force of the R-T-B rare earth sintered magnet.

The atomic ratio of the constituent elements in the R_{L}-T-M₁ based compound in the R-T-B rare earth sintered magnet of the invention preferably satisfies inequalities (1) and (2). If an R_{L}-T-M₁ based compound having the constituent elements in this atomic ratio is present, it will be possible to further increase the coercive force of the R-T-B rare earth sintered magnet.

T>R_{L} (1)

T>M₁ (2)

According to the invention, it is possible to provide an R-T-B rare earth sintered magnet having sufficiently high coercive force without increasing the amount of heavy rare earth element used. In other words, it is possible to produce an R-T-B rare earth sintered magnet having coercive force comparable to that of conventional products, even with reduction in the amount of heavy rare earth element used.

### BRIEF DESCRIPTION OF THE DRAWINGS

FIG. 1 is an electron microscope (TEM) photograph showing the cross-sectional structure of a preferred embodiment of an R-T-B rare earth sintered magnet of the invention.

FIG. 2 is an electron microscope (TEM) photograph showing the cross-sectional structure of the R-T-B rare earth sintered magnet of Comparative Example 1.

### DESCRIPTION OF THE PREFERRED EMBODIMENTS

Preferred embodiments of the invention will now be explained with reference to the accompanying drawings where necessary. For the drawings, identical or corresponding elements will be referred to by like reference numerals and will be explained only once.

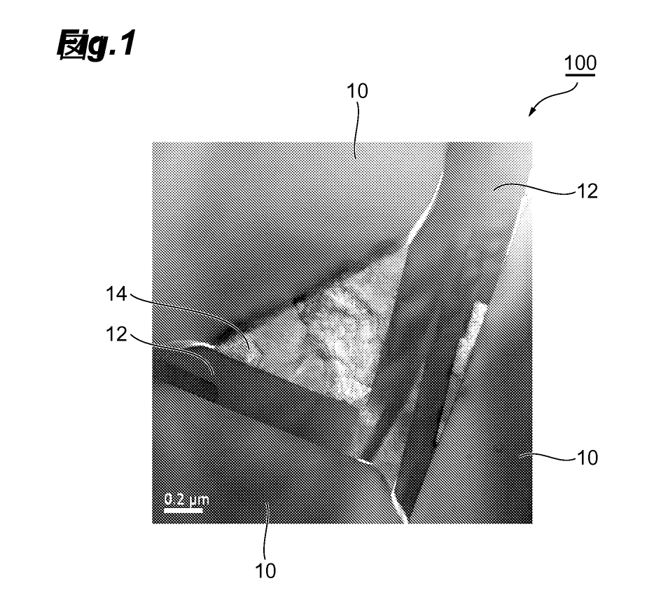

FIG. 1 is a TEM photograph (80,000×) showing the cross-sectional structure of an R-T-B rare earth sintered magnet according to this embodiment. The R-T-B rare earth sintered magnet 100 of this embodiment comprises a main phase 10 containing an intermetallic compound made of R₂T₁₄B, and at the grain boundary triple points, plate crystals 12 comprising an R_{L}-T-M₁ based compound and an R-rich phase 14. As used herein, the main phase 10 is the major crystal grain in the R-T-B rare earth sintered magnet 100. Thus, the constituent component of the crystal grain is the main component in the R-T-B rare earth sintered magnet 100. The volume ratio of the main phase 10 with respect to the entire R-T-B rare earth sintered magnet 100 will generally be at least 90%.

The intermetallic compound in the main phase 10 is a compound composed of R₂T₁₄B. In the formula, R₂T₁₄B, R represents a rare earth element, T represents at least one element selected from among Fe, Co and Cu, and B represents boron. R may be a light rare earth element (R_{L}) or a heavy rare earth element (R_{H}), or it may be a combination of the two.

As used herein, “rare earth element” refers to scandium (Sc) and yttrium (Y), belonging to Group 3, and the lanthanoid elements, of the long Periodic Table. The lanthanoid elements include lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb) and lutetium (Lu). Rare earth elements can be classified as light rare earth elements and heavy rare earth elements. As used herein, “heavy rare earth elements” refers to Gd, Tb, Dy, Ho, Er, Tm, Yb and Lu, and “light rare earth elements” refers to Sc, Y, La, Ce, Pr, Nd, Pm, Sm and Eu.

For R₂T₁₄B in the main phase 10, preferably R is a light rare earth element and more preferably at least one element selected from among Nd, Pr, Sm and Pm, B is present at 0.5-4.5 wt %, with the remainder consisting of T and unavoidable impurities. The compound Nd₂Fe₁₄B may be mentioned as a specific composition. The main phase 10 may also contain other elements as necessary, such as Ni, Mn, Al, Nb, Zr, Ti, W, Mo, V, Ga, Zn and Si. When the main phase 10 contains a heavy rare earth element, the heavy rare earth element preferably includes at least one element selected from among Gd, Dy, Tb and Ho.

The plate crystals 12 comprise an R_{L}-T-M₁ based compound. In the R_{L}-T-M₁based compound, R_{L} represents a light rare earth element, T represents at least one element selected from among Fe, Co and Cu, and M₁ represents at least one element selected from among Al, Zn and Ga. A portion of the T may be replaced with Ni. The atomic ratio of the constituent elements in the R_{L}-T-M₁ based compound preferably satisfies inequalities (1) and (2).

T>R_{L} (1)

T>M₁ (2)

The content of T in the plate crystals 12 is preferably 40-70 atomic percent and more preferably 45-65 atomic percent, based on the total content for all of the elements R_{L}, T and M₁. The content of R_{L} in the plate crystals 12 is preferably 20-35 atomic percent and more preferably 23-33 atomic percent, based on the total content for all of the elements R_{L}, T and M₁. The content of M₁ in the plate crystals 12 is preferably 1-28 atomic percent and more preferably 2-25 atomic percent, based on the total content for all of the elements R_{L}, T and M₁. These element contents will allow an R-T-B rare earth sintered magnet 100 to be obtained with even higher coercive force. Among the elements Al, Zn and Ga, M₁ preferably includes Al, The plate crystals 12 may contain a small amount of at least one type of element selected from among Ag and Au, in addition to R_{L}, T and M₁.

The plate crystals 12 may be present not only at the grain boundary triple points of the R-T-B rare earth sintered magnet 100, but also at the grain boundaries between particles. An R-rich phase 14 may also be present with the plate crystals 12 at the grain boundary triple points. Bach plate crystal 12 has a short axis length of preferably 20-500 nm and a long axis length of preferably 0.4-2 μm, in a cross-section of the R-T-B rare earth sintered magnet 100.

The area ratio of one plate crystal 12 at a grain boundary triple point, in a cross-section of the R-T-B rare earth sintered magnet 100, is preferably 0.01-0.22 and more preferably 0.03-0.18, from the viewpoint of further increasing the coercive force of the R-T-B rare earth sintered magnet 100. This area ratio can be calculated by observing a cross-section of the R-T-B rare earth sintered magnet 100 using TEM, and determining the area of the plate crystal 12 and the grain boundary triple point of the observed image.

The R-rich phase 14 has a higher rare earth element content than the main phase 10, and for example, it may be a eutectic crystal of αNd, αNd and Nd₅Fe₁₇. The rare earth element content in the R-rich phase 14 may be 70-95 atomic percent, for example. If the plate crystals 12 and the R-rich phase 14 are copresent at a grain boundary triple point, it is possible to reduce the atomic ratio of the light rare earth element with respect to the heavy rare earth element (R_{L}/R_{H}) in the R-rich phase 14. This will allow an R-T-B rare earth sintered magnet 100 to be obtained with even higher coercive force. The R_{L}/R_{H} (atomic ratio) in the R-rich phase 14 is preferably no greater than 200 and more preferably no greater than 70.

Since the R-T-B rare earth sintered magnet 100 of this embodiment has sufficiently excellent coercive force, it can be suitably applied in a motor or a generator to be used in a hybrid vehicle or for wind power generation. A high coercive force can also be maintained, compared to a conventional R-T-B rare earth sintered magnet 100, even if the heavy rare earth element content is reduced. This allows the amount of expensive heavy rare earth elements used to be reduced, to lower production costs for the R-T-B rare earth sintered magnet 100.

A preferred composition for the R-T-B rare earth sintered magnet 100 is shown below. The composition can be evaluated by quantitative analysis using an BDX (energy dispersive X-ray) detector.
R_{L}: 21.00-33.50 wt %
R_{H}: 0.00-42.00 wt %
R(=R_{L}+R_{H}): 28.50-35.00 wt %
M₁: 0.10-0.50 wt %
M₂: 0.03-0.50 wt %
B: 0.80-1.50 wt %
C: 0.05-0.30 wt %
N: 0.02-0.15 wt %
O: 0.03-0.60 wt %
T: Remainder

Here, M₂ represents at least one element selected from among Si, Sc, Ti, V, Mo, In, Sn, Bi, Ir, Zr, Hf, Nb and W. T includes Fe and Co as essential elements, with a Co content of 0.05-10.00 wt %, and the total content of Ni and Mn is preferably no greater than 0.2 wt %.

An example of a method for producing an R-T-B rare earth sintered magnet 100 will now be described. The production method comprises a preparation step, in which a starting alloy is prepared, a grinding step in which the starting alloy is ground to obtain a fine starting powder, a molding step in which the fine starting powder is molded to obtain a compact, a sintering step in which the compact is fired to obtain a sintered material, and an aging treatment step in which the sintered material is subjected to aging treatment. Each step will now be explained in detail.

In the preparation step, a starting alloy is prepared comprising each element in the R-T-B rare earth sintered magnet 100. First, the starting metals including the prescribed elements are prepared and used for strip casting or the like. A starting alloy can be prepared in this manner. The starting metals may be, for example, rare earth metals, rare earth alloys, pure iron, ferroboron or alloys thereof. These are used to produce a starting alloy that will yield the desired composition for the rare earth magnet. Multiple alloys with different compositions may also be prepared as the starting alloy.

The grinding step is a step in which the starting alloy obtained in the preparation step is ground to obtain a fine starting powder. This step is preferably carried out in two stages, with a coarse grinding step and a fine grinding step. The coarse grinding step may be carried out in an inert gas atmosphere using, for example, a stamp mill, jaw crusher, Braun mill or the like. Hydrogen absorbed grinding may also be carried out after the hydrogen has been absorbed. In the coarse grinding step, the starting alloy is ground to a particle size of between about several hundred μm and several mm.

In the fine grinding step, the powder (ground product) obtained in the coarse grinding step is subjected to fine grinding, to prepare a fine starting powder with a mean particle size (volume-based cumulative particle size distribution of 50%: D50) of 3-10 μm. The fine grinding may be carried out using a jet mill, for example. The grinding of the starting alloy does not necessarily need to be carried out in two stages with a coarse grinding and fine grinding step, and instead the fine grinding step may be carried out from the start. When different types of starting alloys are prepared, they may be separately ground and then combined.

The molding step is a step in which the fine starting powder is molded in a magnetic field to prepare a compact. Specifically, after the fine starting powder has been packed into the die situated in an electromagnet, a magnetic field is applied by the electromagnet in a low-oxygen atmosphere (oxygen concentration: ≦50 ppm) to orient the crystal axes of the fine starting powder while molding the fine starting powder by compression. Molding of the magnetic field may be carried out, for example, at a pressure of 70-150 MPa in an oriented magnetic field of 1-2 T.

The sintering step is a step in which the compact is fired to obtain a sintered material. Specifically, the compact obtained by molding in the magnetic field may be fired in a vacuum or an inert gas atmosphere to obtain a sintered material. The firing conditions are preferably set as appropriate depending on conditions including the composition, the grinding method and the particle size, and for example, heating may be performed at 1000-1100° C. for 1-5 hours, under a reduced pressure atmosphere of no higher than 1×10⁻² Pa.

The aging treatment step is a step in which the sintered material is subjected to heat treatment to obtain an R-T-B rare earth sintered magnet 100. In order to obtain an R-T-B rare earth sintered magnet with plate crystals 12 at the grain boundary triple points, as in the R-T-B rare earth sintered magnet 100, heat treatment must be performed at 650-800° C. for 3 hours or longer. By carrying out prolonged heat treatment in this temperature range, it is possible to produce plate crystals 12 containing an R_{L}-T-M₁ based compound at the grain boundary triple points of the sintered material. From the viewpoint of even more reliably producing the plate crystals 12, the heating time in the temperature range of 650-800° C. is preferably 5 hours or greater, more preferably 10 hours or greater and even more preferably 25 hours or greater.

By carrying out prolonged heat treatment in this temperature range, it is possible to adequately inhibit grain growth of the main phase while producing an R_{L}-T-M₁ based compound at the grain boundary triple points. There are no particular restrictions on the heating time, but it is preferably no longer than 100 hours from the viewpoint of avoiding prolonging the process.

The aging treatment step is preferably conducted in two stages, from the viewpoint of further increasing the coercive force of the R-T-B rare earth sintered magnet 100. When it is conducted in two stages, the heat treatment for the first stage is performed at 650-800° C. for 5 hours or longer, and preferably at 700-750° C. for 6 hours or longer. The second stage of heat treatment is conducted at 500-600° C. for 0.5-10 hours and preferably at 500-550° C. for 0.5-5 hours. When the aging treatment step is to be carried out in two stages, phase transition will usually occur at the triple points of the sintered material during the first stage. This will allow plate crystals 12 containing an R_{L}-T-M₁ based compound to be obtained. Strain remaining inside the sintered material can also be removed during the second stage.

The R-T-B rare earth sintered magnet 100 obtained by the production method described above has sufficiently high coercive force due to the presence of the R_{L}-T-M₁ based compound at the grain boundary triple points. The method for producing the R-T-B rare earth sintered magnet 100, incidentally, is not limited to the one described above.

The embodiment described above is only a preferred embodiment of the invention, and the invention is in no way limited thereto. For example, while the R-T-B rare earth sintered magnet 100 had an R-rich phase 14 at the grain boundary triple points, the R-T-B rare earth sintered magnet of the invention does not necessarily require an R-rich phase at the grain boundary triple points. In addition, it may also comprise a B-rich phase (for example, R₁₁T₄B₄) at the grain boundaries or grain boundary triple points, in addition to this phase.

### EXAMPLES

The invention will now be explained in greater detail based on examples and comparative examples, with the understanding that the invention is in no way limited to the examples.

[Fabrication of R-T-B Rare Earth Sintered Magnet]

### Example 1

Two different alloys A and B were prepared by a strip casting method, with prescribed compositions. The alloys A and B both contained Al (aluminum) at 0.2 wt %. Alloy A and alloy B were combined in a weight ratio of 9:1 and subjected to coarse grinding. Specifically, hydrogen gas was absorbed into the mixed alloy at room temperature, and then heating at 650° C. for 1 hour under an inert gas atmosphere, followed by dehydrogenation treatment, yielded a ground product. The obtained ground product was then cooled to room temperature under an inert gas atmosphere.

Laurie acid amide powder was added as a grinding aid at 10 wt % to the ground product, and a Nauta mixer was used for mixing under an inert atmosphere for 30 minutes. This was followed by grinding with a high-pressure nitrogen gas jet mill, to obtain a fine starting powder with a mean particle size (volume-based cumulative particle size distribution of 50%: D50) of approximately 4 μm.

The obtained fine starting powder was molded under a low-oxygen atmosphere (argon gas atmosphere with an oxygen concentration of ≦50 ppm), under conditions with an oriented magnetic field of 1.5 T and a molding pressure of approximately 118 MPa, to obtain a compact.

The obtained compact was fired in a reduced pressure atmosphere of no greater than 1×10⁻² Pa, at 1060° C. for 2 hours, to obtain a sintered compact. The sintered compact was subjected to 2-stage aging treatment under the conditions shown in Table 1. The aging treatment was conducted in argon gas at atmospheric pressure. An R-T-B rare earth sintered magnet for Example 1 was thus fabricated.

### Example 2, Comparative Examples 1-3

R-T-B Rare earth sintered magnets were fabricated in the same manner as Example 1, except for using the aging treatment conditions shown in Table 1.

TABLE 1

| | Aging treatment conditions | | | |
|---|---|---|---|---|
| | First stage | | Second stage | |
| | Temperature | | Temperature | |
| | (° C.) | Time (hr) | (° C.) | Time (hr) |
| Example 1 | 700 | 70 | 530 | 1 |
| Example 2 | 700 | 6 | 530 | 1 |
| Comp. Ex. 1 | 800 | 1 | 530 | 1 |
| Comp. Ex. 2 | 800 | 6 | 530 | 1 |
| Comp, Ex. 3 | 700 | 1 | 530 | 1 |

[Evaluation of Magnetic Properties]

The magnetic properties of the R-T-B rare earth sintered magnets of the examples and comparative examples were measured using a BH curve tracer, and the Br (residual magnetic flux density), HcJ (coercive force) and Hk/HcJ (squareness ratio) were determined. The results are summarized in Table 2. The squareness ratio was determined by formula (1) below, using HcJ and Hk. The squareness ratio is an index of the magnet performance, and it represents the angularity of the second quadrant of the magnetic hysteresis loop measured using a B-H tracer. In formula (1), Hk is the external magnetic field intensity at which the ratio of magnetization to residual magnetic flux density is 90% in the second quadrant of the magnetic hysteresis loop.

Squareness ratio (%)=Hc/HcJ×100 (1)

TABLE 2

| | Br (mT) | HcJ (kA/m) | Hk/HcJ (%) |
|---|---|---|---|
| Example 1 | 1429 | 1175 | 98.4 |
| Example 2 | 1437 | 1134 | 97.8 |
| Comp. Ex. 1 | 1436 | 1096 | 98.72 |
| Comp. Ex. 2 | 1425 | 1065 | 98.19 |
| Comp. Ex. 3 | 1434 | 1025 | 83.81 |

[Structure and Composition Evaluation]

A cross-section of each R-T-B rare earth sintered magnet of the examples and comparative examples was observed by TEM-EDS, and the microstructure and composition were evaluated. FIG. 1 is a TEM photograph (magnification: 80,000×) showing the cross-sectional structure of the R-T-B rare earth sintered magnet 100 of Example 1. As seen in FIG. 1, the R-T-B rare earth sintered magnet 100 of Example 1 was confirmed to have multiple plate crystals 12 and an R-rich phase 14 formed at the grain boundary triple points surrounded by multiple R₂T₁₄B crystal grains (main phase 10).

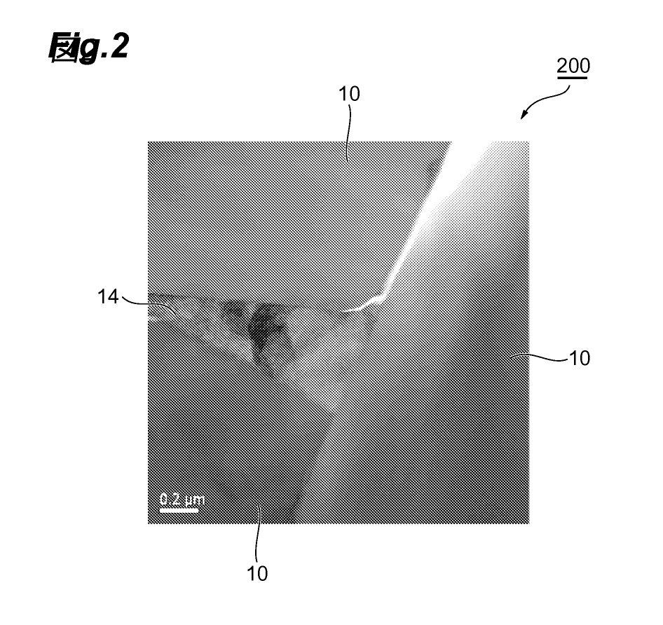

FIG. 2 is a TEM photograph (magnification: 80,000×) showing the cross-sectional structure of the R-T-B rare earth sintered magnet 200 of Comparative Example 1. As seen in FIG. 2, the R-T-B rare earth sintered magnet 200 of Comparative Example 1 had an R-rich phase 14 formed at the grain boundary triple points comprising multiple R₂T₁₄B crystal grains (main phase 10), but no plate crystals 12 had been formed.

EDS was used for compositional analysis of the main phase 10, plate crystals 12 and R-rich phase 14 in each R-T-B rare earth sintered magnet of the examples and comparative examples. The results are shown in Table 3. As seen in Table 3, the plate crystals 12 in the R-T-B rare earth sintered magnet 100 of Example 1 were confirmed to contain an Nd-T-Al-based compound composed mainly of T (Fe, Co, Cu), Al and Nd. The numerical values for each of the elements in Table 3 represent the atomic ratios for each element with respect to the total of R, T and M₁. Presumably, trace elements such as B (boron), Si (silicon), C (carbon) and oxygen (O) are also present in addition to the elements listed in Table 3, but their measurement was difficult.

TABLE 3

| Measured element | | Al | Fe | Nd | Dy | Co | Cu | Total |
|---|---|---|---|---|---|---|---|---|
| Example 1 | Main phase | 2.04 | 86.93 | 9.94 | 0.61 | 0.48 | 0.00 | 100 |
| | R-rich phase | 2.76 | 3.42 | 90.29 | 1.42 | 1.95 | 0.17 | 100 |
| | Plate crystal | 23.36 | 48.04 | 26.47 | 0.00 | 1.50 | 0.64 | 100 |
| Example 2 | Main phase | 2.00 | 86.93 | 10.36 | 0.32 | 0.39 | 0.00 | 100 |
| | R-rich phase | 2.27 | 3.72 | 89.55 | 2.32 | 2.15 | 0.00 | 100 |
| | Plate crystal | 2.31 | 64.42 | 31.38 | 0.22 | 0.91 | 0.75 | 100 |
| Comp. Ex. 1 | Main phase | 2.60 | 85.94 | 10.21 | 0.63 | 0.61 | 0.00 | 100 |
| | R-rich phase | 1.99 | 5.89 | 70.56 | 0.76 | 13.81 | 6.98 | 100 |

The numerical values represent atomic ratio (atom %) of each element with respect to total measured elements.

Next, the area of the grain boundary triple point and the area of each individual plate crystal 12 in a cross-section of the R-T-B rare earth sintered magnet 100 of Example 1 were determined. The ratio of the area of each plate crystal 12 with respect to the area of the grain boundary triple point was also calculated. The areas and their ratios are summarized in Table 4. The areas of the triple points and plate crystals 12 were calculated using elliptical approximation.

TABLE 4

| | Cross-sectional area | |
|---|---|---|
| | (μm²) | Ratio |
| Triple point | 1.1014 | (*1) |
| Plate crystal a | 0.0143 | 0.0130 |
| Plate crystal b | 0.1968 | 0.1787 |
| Plate crystal c | 0.0391 | 0.0355 |
| Plate crystal d | 0.1592 | 0.1445 |
| Plate crystal e | 0.0912 | 0.0828 |
| Plate crystal f | 0.1282 | 0.1164 |

(*1): Ratio of cross-sectional area of plate crystal with respect to cross-sectional area of triple point.

The ratio of the area of each individual plate crystal with respect to the area of the total triple point in a cross-section of the R-T-B rare earth sintered magnet 100 was confirmed to be in the range of 0.01-0.18. Also, the plate crystal area was confirmed to be in the range of 0.014-0.20 μm².

According to the invention, it is possible to provide an R-T-B rare earth sintered magnet having sufficiently high coercive force without increasing the amount of heavy rare earth element used.

What is claimed is:

1. An R-T-B rare earth sintered magnet comprising:
an R₂T₁₄B-containing crystal grain as the main phase, and
an R_{L}-T-M₁ based compound at the grain boundary triple points,
wherein R represents a rare earth element, T represents at least one element selected from among Fe, Co and Cu, B represents boron, R_{L} represents a light rare earth element, and M₁ represents at least one element selected from among Al, Zn and Ga.

2. The R-T-B rare earth sintered magnet according to claim 1, which has plate crystals comprising the R_{L}-T-M₁ based compound at the grain boundary triple points.

3. The R-T-B rare earth sintered magnet according to claim 1, wherein the ratio of the area of the plate crystals comprising the R_{L}-T-M₁ based compound with respect to the area of the grain boundary triple points, based on a cross-section, is 0.01-0.22.

4. The R-T-B rare earth sintered magnet according to claim 2, wherein the ratio of the area of the plate crystals comprising the R_{L}-T-M₁ based compound with respect to the area of the grain boundary triple points, based on a cross-section, is 0.01-0.22.

5. The R-T-B rare earth sintered magnet according to claim 1, wherein the atomic ratio of the constituent elements in the R_{L}-T-M₁ based compound satisfies inequalities (1) and (2).
T>R_{L} (1)
T>M₁ (2)

6. The R-T-B rare earth sintered magnet according to claim 2, wherein the atomic ratio of the constituent elements in the R_{L}-T-M₁ based compound satisfies inequalities (1) and (2).
T>R_{L} (1)
T>M₁ (2)

7. The R-T-B rare earth sintered magnet according to claim 3, wherein the atomic ratio of the constituent elements in the R_{L}-T-M₁ based compound satisfies inequalities (1) and (2).
T>R_{L} (1)
T>M₁ (2)
